(19) United States
(12) Patent Application Publication
(10) Pub. No.: US 2011/0168728 A1
(43) Pub. Date: Jul. 14, 2011

(54) INTERNAL TIE FOR A FLUID STORAGE TANK

(75) Inventors: Terry McDermott, Lugarno NSW (AU); Neil Wallace, Albion Park NSW (AU)

(73) Assignee: BLUESCOPE STEEL LIMITED, Melbourne (AU)

(21) Appl. No.: 12/959,097

(22) Filed: Dec. 2, 2010

(30) Foreign Application Priority Data
Dec. 2, 2009 (AU) 2009243485

(51) Int. Cl. B65D 8/08; B23P 11/00; F16M 13/00

(52) U.S. Cl. 220/653; 29/428; 248/309.1; 248/201

(57) ABSTRACT

A fluid storage tank having opposite upper and lower ends, a tank wall extending between the ends, and an internal tie assembly to assist the tank wall to resist hydrostatic pressure induced by fluid in the tank, the internal tie assembly comprising an elongate tie having spaced apart couplings, and a plurality of retaining formations fixed to, or integrally formed on, an inner surface of the tank wall, wherein the couplings of said tie are arranged to be received in respective ones of said retaining formations to connect said tie to said tank wall so that said tie is able to resist outward deformation of said tank wall.

### TECHNICAL FIELD

The present invention relates generally to fluid storage tanks and more specifically to improvements in metal water tanks The invention has been developed especially, but not exclusively, for rainwater storage tanks for domestic use and is herein described in that context. However, it is to be appreciated that the invention has broader application and is not limited to that particular use. For example, the tank may also be used in agriculture, aquaculture or viticulture.

### BACKGROUND OF THE INVENTION

Traditionally, metal rainwater tanks have been made from corrugated metal panels which are formed with a circular cross section. The use of this circular form is beneficial as it well suited to accommodate the hoop tension induced in the tank by the hydrostatic pressures of the water. Whilst the circular water tanks are suited to resist the hydrostatic pressures, they are not particularly well suited for domestic applications because of aesthetic reasons and also because of space requirements.

In view of these limitations, in recent times, new designs of water tanks have been developed primarily for domestic use. The designs are generally thinner and are of rectangular or obround cross section where the major front and back faces are significantly longer than side walls which interconnect the front and back faces. These designs are ideally suited to be located against building walls where they may be more easily accommodated and also where they will be less intrusive.

In the past, difficulties have been encountered in producing tanks, either in the original circular form, or in the generally thinner form, that are easy to manufacture and well suited to accommodate the hydrostatic pressures induced in the tank. Traditionally, prior art metal circular water tanks are assembled by hand thereby limiting the opportunity to reduce the cost of manufacture of such tanks Plastic versions of these tanks are not self supporting and therefore require separate support and frames to be provided. These frames typically require extensive bridging which extend intermediate the tank and as such, the frames not only significantly increase the cost of manufacture of the tank, but can substantially reduce its storage capacity.

### SUMMARY OF THE INVENTION

In yet a first aspect, the invention relates to a fluid storage tank having opposite upper and lower ends, a tank wall extending between the ends, and an internal tie assembly to assist the tank wall to resist hydrostatic pressure induced by fluid in the tank, the internal tie assembly comprising an elongate tie having spaced apart couplings, and a plurality of retaining formations fixed to, or integrally formed on, an inner surface of the tank wall, wherein the couplings of the tie are arranged to be received in respective ones of the retaining formations to connect the tie to the tank wall so that the tie is able to resist outward deformation of the tank wall.

In a particular form, the tie is formed from a rod and the couplings are formed at end portions of the rod. In one form, the rod which is preferably made of metal such as stainless steel includes a main portion that extends generally in a first direction and the couplings are formed by turning the end portions of the rod out of the first direction. These end portions may extend substantially normal to the first direction.

In one form, the retaining formations comprise slots which are arranged to receive respective ones of the couplings of the tie. In a particular form, the slots face upwardly to allow tie couplings to be received in the slots under downward movement of the tie.

In one embodiment, the retaining formations are disposed on an elongate member (or bracket) which in turn is fixed to the inner wall of the tank. In one form, this bracket is formed as a metal section and may include a plurality of retaining formations so that a single bracket may receive one coupling of a plurality of ties. In this way the tank may comprise a plurality of tie assemblies which share a common pair of brackets.

In a particular form, a plurality of the ties is disposed one beside the other in the tank. In one form, there are a greater number of ties disposed at a lower end of the tank as compared to an upper end to cater for the greater hydrostatic pressure experienced at the lower end of the tank when it is full.

In a particular construction of tank, the tank wall is generally rectangular or obround and includes opposite side walls interconnecting opposite end walls, and wherein the or at least one of the ties interconnect the side walls.

In a particular embodiment, the elongate member is formed as a metal section having an outer flange and the retaining formation(s) are formed in that flange. In a particular arrangement, at least one portion of the outer flange is displaced outwardly relative to an adjacent portion of the flange to form, in use, an upwardly facing slot that comprises a respective one of the retaining formations. In a particular form, the adjacent portion of the top flange includes a channel that leads into the upwardly facing slot. In a particular form, the elongate member is in the form of a top hat section.

In a further aspect, the invention is directed to a bracket for a fluid storage tank tie assembly, the bracket comprising an elongate section having an outer flange, wherein at least one portion of the outer flange is displaced outwardly relative to an adjacent portion of the flange to form a slot that faces along said flange and which forms a retaining formation for said tie assembly.

In yet a further aspect, the invention is directed to a method of installing a tie in a fluid storage tank comprising the step of connecting the tie to spaced apart retaining formations disposed on an inner wall of the storage tank whereby the tie is moved downwardly within the tank to cause spaced couplings on the tie to engage with respective ones of the retaining formations.

In one form, the tank wall is formed from one or more lengths of sheet material. In a particular form, the sheet material is sheet metal and preferably sheet steel that incorporates a corrosion resistant metal coating and a polymeric film overlay.

The tank wall may be formed in a conventional manner where sheet metal strip is cut into sheets that are formed into cylinders by interconnecting the ends of respective sheets. The tank wall height is built up by placing subsequent sheets onto previous sheets that are formed to cylinders. Alternatively, the tank wall may be formed by a process of helically winding one or more sheets. In this latter arrangement, each sheet is helically wound about the tank axis, and the wall further comprises at least one seam extending helically about the tank axis that interconnects adjacent longitudinal edges of the or each sheet and forms a watertight joint along those edges.

In one form, the tank wall incorporates at least one stiffening formation. In a particular form, each stiffening formation includes at least one rib that extends helically about the tank axis.

In a particular form, the fluid storage tank is a water storage tank.

Accordingly a tie assembly for a fluid storage tank is disclosed that is effective, inexpensive to manufacture and easy to install. By providing the retaining formations of the tie assembly on elongate members allows the loading induced on the ties to be distributed thereby reducing point loading. Further the tie assembly in at least one form provides a simple “drop in” connection arrangement, where the couplings on the tie locate directly in upwardly facing slots which form the retaining formations.

### BRIEF DESCRIPTION OF THE DRAWINGS

It is convenient to hereinafter describe an embodiment with reference to the accompanying drawings. Particularly of these drawings and the related description is to be understood as not superseding the generality of the preceding broad description of the invention.

In the drawings:

FIG. 1 is a perspective view of a water tank;

FIG. 2 is a sectional view along section line II-II of the tank of FIG. 1;

FIG. 3 is a sectional view along section line III-III of the tank of FIG. 1;

FIG. 4 is a detailed view of a tie of a tie assembly used in the tank of FIG. 1;

FIG. 5 is a detailed view of a bracket of a tie assembly used in the tank of FIG. 1; and

FIG. 6 is a sectional view along section line VI-VI of the bracket of FIG. 5.

### DETAILED DESCRIPTION OF THE DRAWINGS

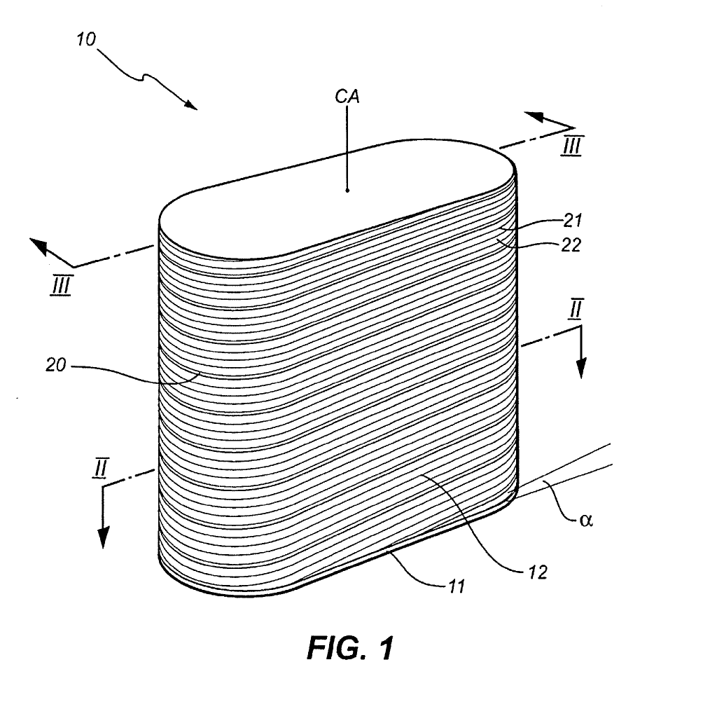

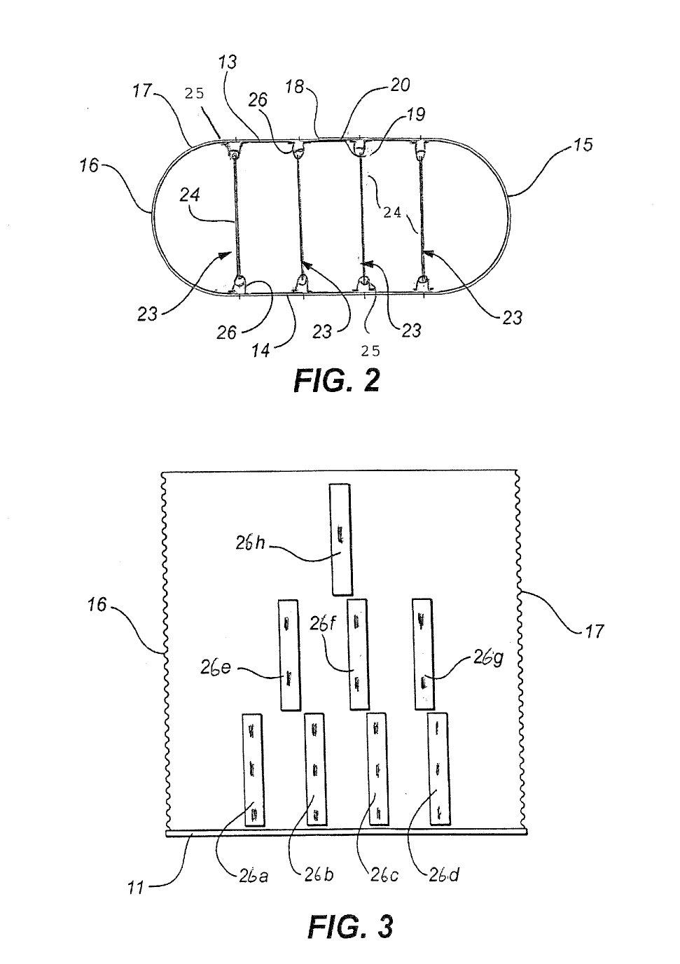

Turning firstly to FIGS. 1 and 2, a rainwater storage tank 10 is disclosed which is generally obround in cross section. The tank includes a base 11 and tank wall 12 which extends upwardly from the base. The tank wall 12 includes opposite generally parallel sides 13 and 14 and generally semi-circular ends 15 and 16.

The tank 10 is made from sheet metal, with the tank wall 12 being formed by a single length of metal sheet 17, which is helically wound around a central axis (CA) of the tank. To ensure that the tank wall 12 is continuous, a lock seam 20 is provided which interconnects the opposing longitudinal edges 18, 19 of the sheet metal strip 17 that locate adjacent one another when the strip 17 is wound in a helix. The lock seam 20 similarly extends helically about the tank axis CA.

The sheet metal strip 17 may be profiled to include a plurality of ribs 21 which extend in the longitudinal direction of the sheet metal strip 17. In the illustrated form of FIG. 1, the sheet metal strip is profiled to include three ribs 21 which are in close proximity to each other and pans 22 located adjacent the ribs 21.

The ribs 21 are provided to stiffen the sheet strip 17 so that it is better able to accommodate the hydrostatic pressures induced in use of the tank 10. These ribs are typically formed from a cold roll forming operation. Tanks that are formed using a helically winding process is the subject of an earlier application WO 2005/005738 filed by the applicant, and the contents are herein incorporated by cross reference. It is to be appreciated however that the tank may be formed using other manufacturing processes and using other profiles and materials as will be appreciated by those skilled in the art.

Turning back to the form as illustrated in FIG. 1, the sheet 17 is helically wound so that the pitch angle a as illustrated in FIG. 1 is relatively low and is typically in the range of 0.1 to 5°. Further, in the illustrated form, the ribs 21 project outwardly from the tank. However it is to be appreciated that the tank may be wound so that the ribs extend inwardly. This latter option has the advantage as it provides a smoother exterior surface with the outer surface of the pans 22 forming the outer margins of the tank wall 12.

The sheet metal strip 17 is formed from a high tension or mild steel which typically has thickness of 0.35-3.0 mm and incorporates a protective coating which is formed from zinc or a zinc mixture. The sheet steel may also be laminated with a protective polymer based film which provides superior chemical resistance and enhanced moisture barrier. One such polymer film is sold under the trade mark TRENCHCOAT LG which is a trade mark of the Dow Chemical Company. The thickness of the coating is preferably in the range of 100 to 400 microns.

Whilst not shown, the tank 10 typically also includes a lid which incorporates an inlet pipe to the tank 10. An outlet (also not shown) is also typically provided adjacent the base 11.

FIGS. 2 and 3 illustrate internal tie assemblies (generally designated 23) which interconnect opposite side walls 13 and 14 of the tank wall 12 so that the wall is better able to accommodate the hydrostatic pressures induced in the tank in use. In particular, The tie assemblies 23 are arranged to resist outward bowing of the tank wall 12 under those hydrostatic pressures. In use, a plurality of the tie assemblies may be disposed within the tank 10 between its upper and lower ends. The spacings between the ties assemblies 23 may vary along the tank and in particular, be more closely spaced towards the bottom of the tank 10 where the hydrostatic pressures are at their highest.

In the form as shown in FIGS. 2 and 3, the tie assemblies 23 comprise ties which are in the form of stainless steel rods 24, and retaining formations 25 in which the rods 24 locate and which are connected to, or integrally formed with, the tank wall 12. In the form as illustrated these retaining formations 25 comprise upwardly facing slots which are formed on elongate brackets 26 which are fixed to the internal surface 27 of the tank wall 20. The brackets 26 (best seen in FIGS. 5 and 6) extend in use generally vertically and may be fixed to the wall using any suitable mechanical fastening arrangement or by a welding process or through the use of an adhesive.

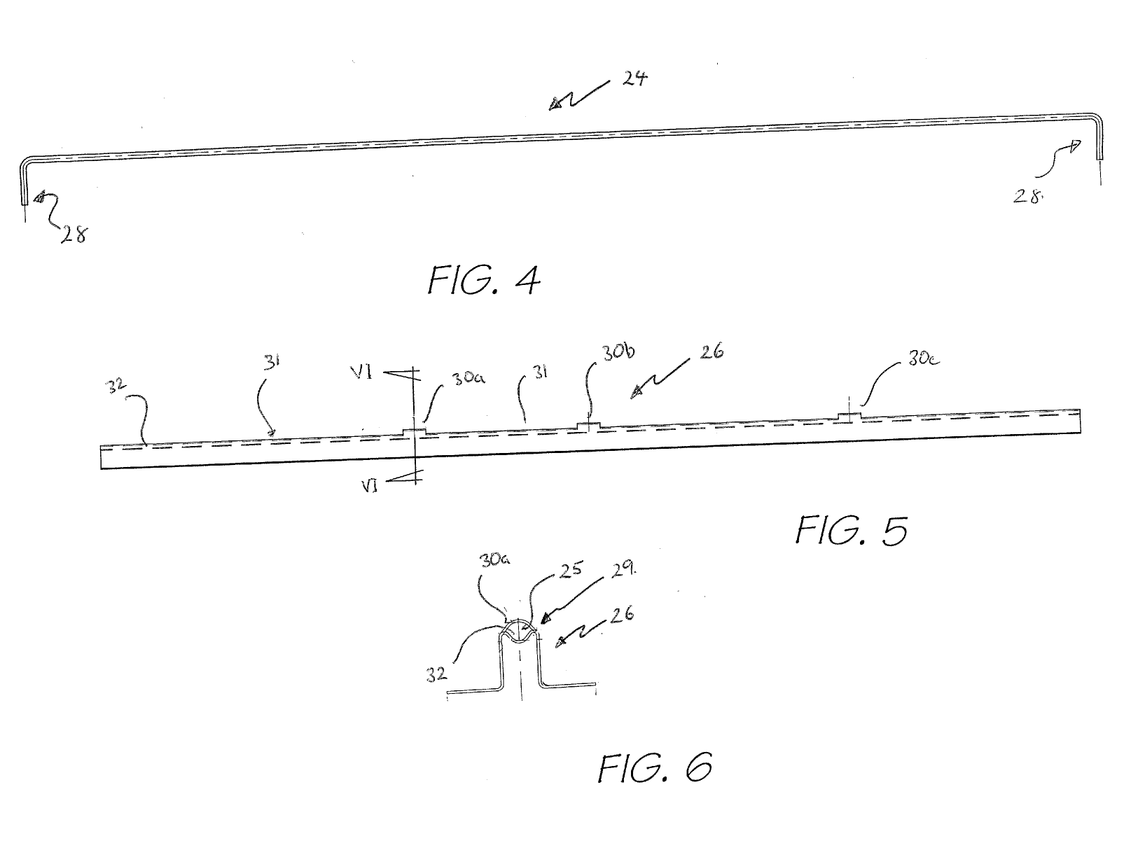

As best illustrated in FIG. 4, the ties 24 are formed from the stainless steel rods and incorporate turned end portions 28 which form couplings of the ties and which are arranged to be received in the slots 25 of the brackets 26. These end portions are preferably turned through 90° as shown.

As illustrated in FIGS. 5 and 6, the brackets 26 are formed as a metal section (in the present form a top hat section) and includes a top flange 29 in which the slots 25 are formed. To enable the slots to extend upwardly when the bracket is installed in its vertical orientation, portions (30a, 30b, and 30c) of the flange 29 are pressed out relative to the major portion 31 of the top flange 29. Furthermore the major portion 31 includes a groove 32 running along its length which increases the effective size of the slots 25 which are formed between the major portion 31 and the respective pressed out portions 30a, 30b and 30c.

The ties 24 extend between pairs of respective brackets and are arranged to be installed simply by dropping the ties into place so that the turned end portions 28 locate in the upturned slots 25. To prevent the ties from disengaging from the bracket retention devices (not shown) such as cable ties may be used to inhibit lifting of the ties relative to the brackets.

The use of the brackets 26 provide rigidity to the tank wall and accordingly improve the structural performance of the tank 10, even if the ties 24 are not used. When used as part of a tie assembly, the brackets 26 allowing a convenient anchor point for the ties and reduce point loading on the tank wall as the brackets allow the loading from the elements to be better distributed across that member.

FIG. 3 illustrates a typically set out for the tie assemblies 23 in the tank 10. As the hydrostatic pressures are higher in the lower section of the tank, the tank includes a series of four closely spaced brackets (26a, 26b, 26c, 26d) located next to each other on each of the opposite side walls of the tank. These brackets only extend part way up the tank wall and located above those brackets are three further brackets (26e, 26f, 26g) and, located on top of the pair of bracket is a single bracket 26h. In this way, the layout of the bracket reflects the need for different strength at different depths in the tank 10.

Corresponding brackets on each of the opposite sides of the tank wall are interconnected by the ties 24. Whilst the layout of the ties may vary depending on the necessary requirements, in the illustrated form, each the lower brackets receive three ties, whereas the middle brackets receive two ties, and the top bracket receives only one tie. As such the spacing of the ties varies along the depth of the tank with the ties being more closely spaced at the bottom.

In accordance with the present invention, an improved water tank and internal tie arrangement is disclosed. The ties can be fitted to the tank post forming and allow for variation in the strength at different depth levels. Also the ties reduce point loading at the tie fixing points on the tank wall. Moreover, the tie assemblies are inexpensive to manufacture and have a simple drop in system to allow for ease of installation.

In the claims which follow and in the preceding description of the invention, except where the context requires otherwise due to express language or necessary implication, the word “comprising” is used in an inclusive sense, i.e. the features specified may be associated with further features in various embodiments of the invention.

Variations and or modifications may be made to the parts previously described without departing from the spirit or ambient of the present invention.

1. A fluid storage tank having opposite upper and lower ends, a tank wall extending between the ends, and an internal tie assembly to assist the tank wall to resist hydrostatic pressure induced by fluid in the tank, the internal tie assembly comprising an elongate tie having spaced apart couplings, and a plurality of retaining formations fixed to, or integrally formed on, an inner surface of the tank wall, wherein the couplings of said tie are arranged to be received in respective ones of said retaining formations to connect said tie to said tank wall so that said tie is able to resist outward deformation of said tank wall.

2. A fluid storage tank according to claim 1, wherein the tie is formed from a rod and the couplings are formed at end portions of the rod.

3. A fluid storage tank according to claim 2, wherein the tie includes a main portion that extends generally in a first direction and the couplings are formed by turning the end portions of the rod out of the first direction.

4. A fluid storage tank according to claim 3, wherein the end portions extend substantially normal to said first direction.

5. A fluid storage tank according to claim 1, wherein the retaining formations comprise slots in which a said coupling of the tie is arranged to be received.

6. A fluid storage tank according to claim 5, wherein said slots face upwardly to allow said tie couplings to be received in the slots under downward movement of the tie.

7. A fluid storage tank according to claim 5, wherein at least one of the retaining formations is disposed on an elongate member which is arranged to be fixed to the tank inner wall.

8. A fluid storage tank according to claim 7, wherein the elongate member includes a plurality of spaced apart said retaining formations disposed thereon.

9. A fluid storage tank according to claim 7, wherein the elongate member is formed as a metal section having an outer flange, and wherein the or each retaining formation is formed by a slot formed in said top flange.

10. A fluid storage tank according to claim 9, wherein at least one portion of the outer flange is displaced outwardly relative to an adjacent portion of the flange to form, in use, an upwardly facing slot that comprises a respective one of the retaining formations.

11. A fluid storage tank according to claim 10, wherein the elongate member extends generally vertically along said tank wall, and said slot faces towards one end of said member.

12. A fluid storage tank according to claim 10, wherein the adjacent portion of the top flange includes a channel that leads into said upwardly facing slot.

13. A fluid storage tank according to any one of claims 9, wherein the elongate member is formed as a top hat section.

14. A fluid storage tank according to claim 7, wherein said tank includes a plurality of said tie assemblies with at least some of the ties of the respective assemblies being disposed at different heights in the tank and wherein a plurality of ties are connected to two said elongate members fixed to the tank wall, the elongate members each having a plurality of retaining formations spaced along the member and each said retaining formation receiving a respective coupling of the plurality of ties.

15. A bracket for a fluid storage tank tie assembly, the bracket comprising an elongate section having an outer flange, wherein at least one portion of the outer flange is displaced outwardly relative to an adjacent portion of the flange to form a slot that faces along said flange and which forms a retaining formation for said tie assembly.

16. A bracket according to claim 15, wherein the adjacent portion of the top flange includes a channel that leads into said slot.

17. A bracket according to claim 16, wherein the elongate member is formed as a top hat section.

18. A tie assembly for a fluid storage tank comprising a plurality of brackets according to claim 15, and one or more ties, each tie comprising a rod having spaced apart couplings which are each receivable in a said slot of respective ones of the brackets.

19. A method of installing a tie in a fluid storage tank comprising the step of:
connecting the tie to spaced apart retaining formations disposed on an inner wall of the storage tank whereby the tie is moved downwardly within the tank to cause spaced couplings on the tie to engage with respective ones of the retaining formations.
